(19) United States
(12) Patent Application Publication
(10) Pub. No.: US 2026/0049858 A1
(43) Pub. Date: Feb. 19, 2026

(54) FILL LEVEL DETECTION SYSTEM

(71) Applicant: Austin S. Bloor, Orlando, FL (US)

(72) Inventor: Austin S. Bloor, Orlando, FL (US)

(21) Appl. No.: 18/807,434

(22) Filed: Aug. 16, 2024

(51) Int. Cl. G01F 23/296

(52) U.S. Cl. CPC G01F 23/296

(57) ABSTRACT

A fill level detection system can include an ultrasonic fill level sensor that includes a sensing portion; a sensor mount that includes a cradle portion, a clamping portion, and an underside protective portion; the clamping portion can be unmounted so that the ultrasonic fill level sensor is not retained by the clamping portion while the cradle portion is mounted on a top surface of a lid of a container; the underside protective portion can be mounted on a bottom surface of the lid of the container; the underside protective portion has a second through-cavity that is aligned with a first through-cavity of the cradle portion and an aperture in the lid of a container; and the second through-cavity at least partially receives the sensing portion of the ultrasonic fill level sensor so that the sensing portion does not extend below a bottom surface of the underside protective portion.

### TECHNICAL FIELD

The embodiments generally relate to the field of fill level detection systems.

### BACKGROUND

Typical fill level detection systems can include non-removable sensor components which make it difficult to replace or service sensors while containers are being filled with material.

There is a need for removable sensor components in a fill level detection system to make replacing or servicing sensors more efficient.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

In general, the disclosed fill level detection system can include an ultrasonic fill level sensor that includes a sensing portion; a sensor mount that includes a cradle portion, a clamping portion, and an underside protective portion; wherein: the cradle portion is constructed and arranged to be mounted on a top surface of a lid of a container; the cradle portion has a first through-cavity that is constructed and arranged to receive at least the ultrasonic fill level sensor; the first through-cavity is further constructed and arranged to be aligned with an aperture in the lid of the container; the sensing portion of the ultrasonic fill level sensor is sized to extend through the aperture in the lid of the container; the clamping portion is constructed and arranged to be mounted on the cradle portion; the clamping portion is further constructed and arranged to extend over at least the ultrasonic fill level sensor and retain the ultrasonic fill level sensor while the ultrasonic fill level sensor is received in the first through-cavity of the cradle portion; the clamping portion is further constructed and arranged to be unmounted so that the ultrasonic fill level sensor is not retained by the clamping portion while the cradle portion is mounted on the top surface of the lid of the container; the underside protective portion is constructed and arranged to be mounted on a bottom surface opposite the top surface of the lid of the container; the underside protective portion has a second through-cavity that is constructed and arranged to be aligned with the first through-cavity of the cradle portion and the aperture in the lid of the container; and the second through-cavity is further constructed and arranged to at least partially receive the sensing portion of the ultrasonic fill level sensor so that the sensing portion does not extend below a bottom surface of the underside protective portion; the fill level detection system further comprising: memory; and one or more processors operably coupled to at least the memory and the ultrasonic fill level sensor, the one or more processors configured at least to: receive first sensor information from the ultrasonic fill level sensor; determine that a fill level of the container meets a predetermined threshold based at least on the received first sensor information.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates an exploded view of a fill level detection system, according to some embodiments disclosed herein;

FIG. 2 illustrates a top view of a fill level detection system being mounted on a lid, according to some embodiments disclosed herein;

FIG. 3 illustrates a bottom view of a lid of a container with the fill level detection system omitted, according to some embodiments disclosed herein;

FIG. 4 illustrates a perspective view of a fill level detection system mounted on a lid, according to some embodiments disclosed herein;

FIG. 5 illustrates a side view of a fill level detection system mounted on a lid, according to some embodiments disclosed herein;

FIG. 6 illustrates a side view of a fill level detection system with the clamping portion unmounted from the cradle portion, according to some embodiments disclosed herein;

FIG. 7 illustrates a bottom view of a fill level detection system mounted to a lid with the sensing portion omitted, according to some embodiments disclosed herein;

FIG. 8 illustrates a bottom view of a fill level detection system mounted to a lid with the sensing portion received in an aperture of the lid, according to some embodiments disclosed herein;

FIG. 9 illustrates a fill level detection system that includes a plurality of sensor mounts and a plurality of ultrasonic fill level sensors, according to some embodiments disclosed herein;

FIG. 10 illustrates indicator light sources and audio alarms of a fill level detection system, according to some embodiments disclosed herein;

FIG. 11 illustrates a block diagram of a system for detecting fill levels, according to some embodiments disclosed herein; and

FIG. 12 illustrates a block diagram of a computing device such as a controller or a user device, according to some embodiments disclosed herein.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described product or methods of use. Any specific details of the embodiments are used for demonstration purposes only and no unnecessary limitations or inferences are to be understood from there.

It is noted that the embodiments reside primarily in combinations of components and procedures related to the products. Accordingly, the product and components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to a fill level detection system. In some embodiments, the fill level detection system is a removeable sensor fill level detection system. The fill level detection system can include a fill level sensor that includes a sensing portion. The fill level detection system can include a sensor mount that includes a cradle portion, a clamping portion, and an underside protective portion. The clamping portion can extend over at least the fill level sensor and retain the ultrasonic fill level sensor while the fill level sensor is received in the cradle portion. The clamping portion can be unmounted so that the fill level sensor is not retained by the clamping portion while the cradle portion is mounted on the top surface of the lid of the container. The underside protective portion can be mounted on a bottom surface opposite the top surface of the lid of the container, and receive the sensing portion of the fill level sensor so that the sensing portion does not extend below a bottom surface of the underside protective portion. The sensing portion does not extend below the bottom surface of the underside protective portion so that the underside protective portion can protect the sensing portion from being damaged when the lid is moved (e.g., from one container to another container).

The fill level detection system can be used while a container is being filled with material. In some embodiments, the material can include solids, liquids, or a combination thereof. In some embodiments, the material can include waste such as, for example, dust or debris.

The fill level detection system can include memory and one or more processors operably coupled to at least the memory and the fill level sensor. The one or more processors can be configured at least to receive sensor information from the fill level sensor and determine that a fill level of the container meets a predetermined threshold based at least on the received sensor information. In some embodiments, the fill level of the container increases while the container is being filled with material. In some embodiments, the fill level of the container indicates an amount of the material in the container.

The sensor mount can primarily include any suitable durable material(s) for mounting the fill level sensor such as, for example, plastic, wood, metal, or any combination thereof. In some embodiments, the sensor mount can be impervious to harsh conditions such as preventing ultraviolet light damage or other damage from common exterior environmental situations such as snow, ice, rain, etc. In some embodiments, the sensor mount can be made via machining, 3D printing, extrusion, or other manufacturing methods.

In some embodiments, the fill level sensor can include an ultrasonic fill level sensor. In some embodiments, the ultrasonic fill level sensor can include one or more suitable sensor(s) that are configured to at least emit an ultrasonic sound wave in a container, receive a returned sound wave, and send sensor information to at least the one or more processors based at least on the emitted ultrasonic sound wave, the returned sound wave received by the ultrasonic fill level sensor, the time the ultrasonic sound wave was emitted, the time the returned sound wave was received by the ultrasonic fill level sensor, the determined time difference between the time the ultrasonic sound wave was emitted and the time the returned sound wave was received, or any combination thereof.

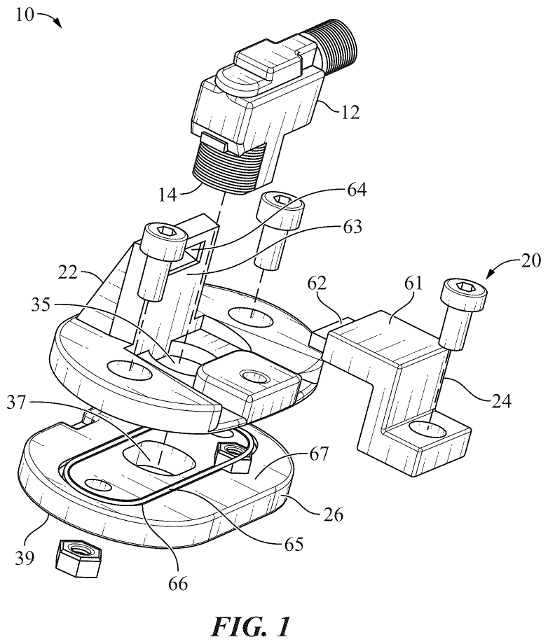

Referring to FIG. 1, a fill level detection system 10 can include a fill level sensor such as, for example, an ultrasonic fill level sensor 12 that includes a sensing portion 14. In some embodiments, sound waves can pass through the sensing portion 14. In some embodiments, sound waves can be received through the sensing portion 14. In some embodiments, sound waves can be emitted by the sensing portion 14. In some embodiments, sound waves can be received by the sensing portion 14.

In some embodiments, a sensor mount 20 can include a cradle portion 22, a clamping portion 24, and an underside protective portion 26. In some embodiments, the cradle portion 22 has a first through-cavity 35 that is constructed and arranged to receive at least the ultrasonic fill level sensor 12.

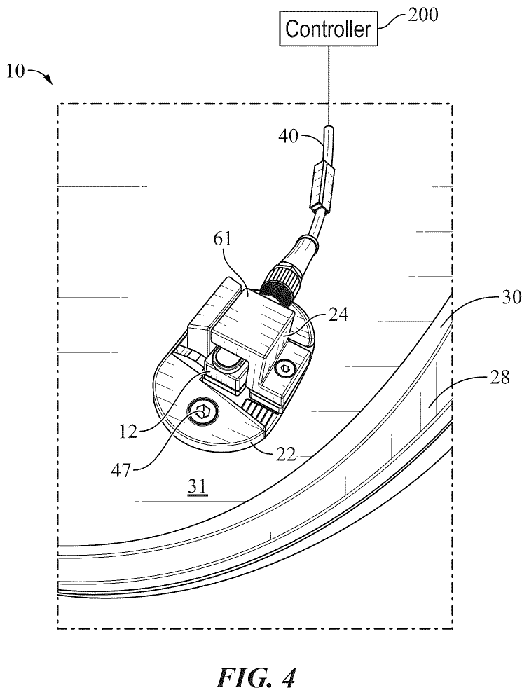

In some embodiments, the clamping portion 24 can include a top jaw 61 and a retaining protrusion 62 extending from the top jaw 61, the top jaw 61 being constructed and arranged to be positioned on at least the ultrasonic fill level sensor 12 as shown in FIG. 4. Referring back to FIG. 1, in some embodiments, the cradle portion 22 can have a vertical wall 63 that includes a retaining hole 64. The retaining hole 64 in the vertical wall 63 can be constructed and arranged to receive the retaining protrusion 62 of the clamping portion 24 to retain the ultrasonic fill level sensor 12 as shown in FIG. 4.

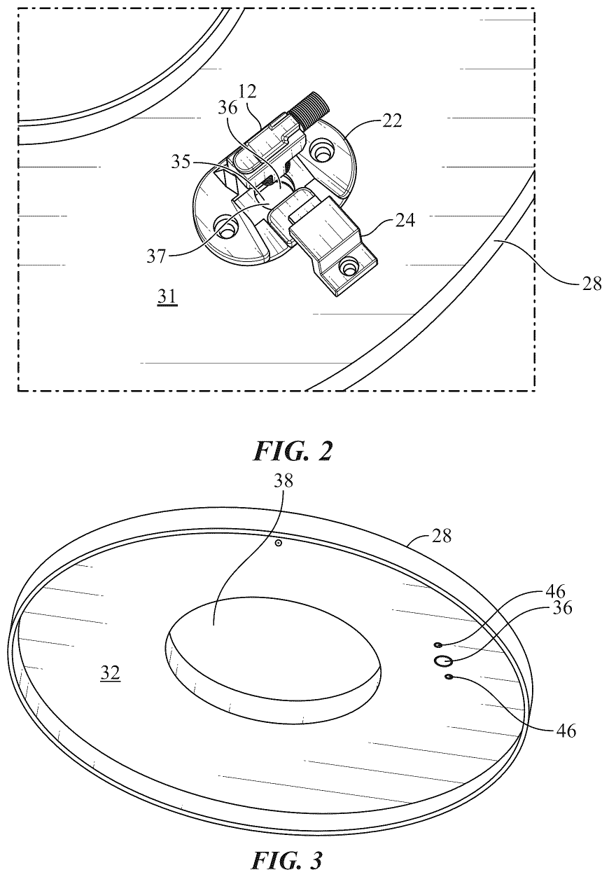

Referring to FIG. 2, the first through-cavity 35 of the cradle portion 22 can be constructed and arranged to be aligned with an aperture 36 in a lid 28 of a container (e.g., 30 in FIG. 4). In some embodiments, the cradle portion 22 can be constructed and arranged to be mounted on a top surface 31 of the lid 28 of the container 30.

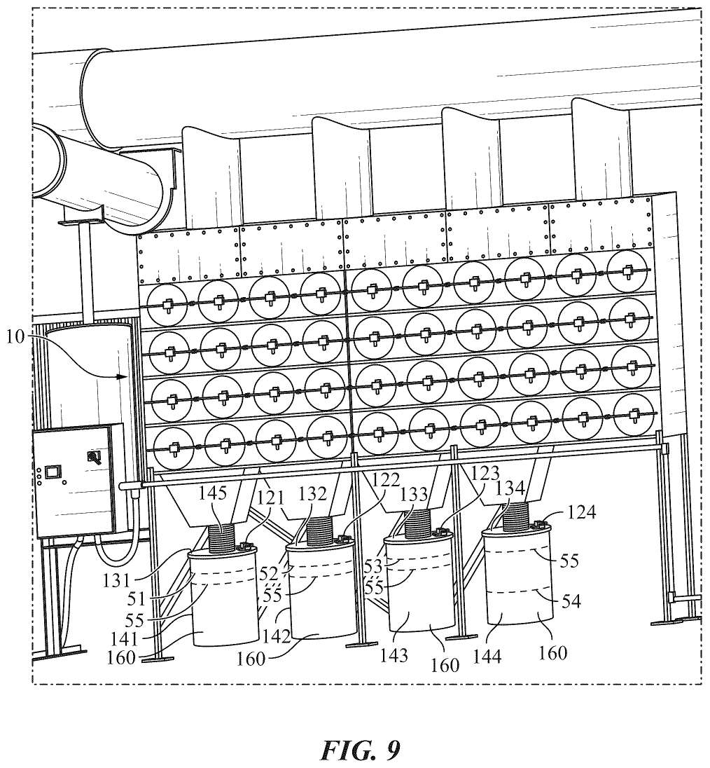

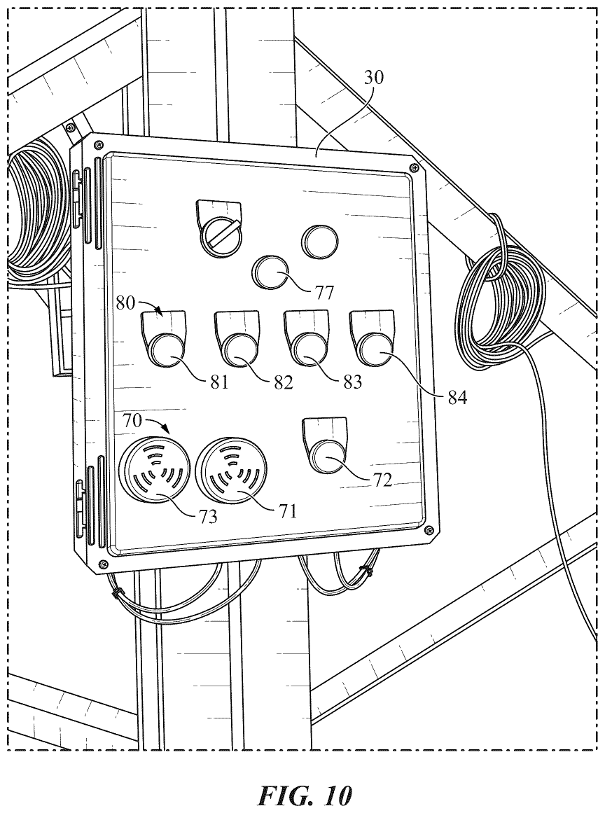

Referring to FIG. 3, the lid 28 of a container (e.g., 30 in FIG. 4) is shown with the fill level detection system 10 omitted. The lid 28 includes the aperture 36, and one or more fastener holes 46 for receiving one or more fasteners (e.g., 47 in FIG. 4) that mount the fill level detection system 10 to the lid 28. In some embodiments, the lid 28 can include a second aperture 38 that is larger than the aperture 36. In some embodiments, the second aperture 38 can be centrally positioned in the lid 28, and sized to allow any suitable material (e.g., solids or liquids) to pass therethrough. In some embodiments, the second aperture 38 can be sized to receive a tube (e.g., 145 in FIG. 9) that is constructed and arranged to feed suitable material to the container (e.g., 30 in FIG. 4).

Referring to FIG. 4, in some embodiments, the clamping portion 24 can be constructed and arranged to extend over at least the ultrasonic fill level sensor 12 and retain the ultrasonic fill level sensor 12 while the ultrasonic fill level sensor 12 is received in the first through-cavity (e.g., 35 in FIGS. 1 and 2) of the cradle portion 22. In some embodiments, the clamping portion 24 can be constructed and arranged to be mounted on the cradle portion 22.

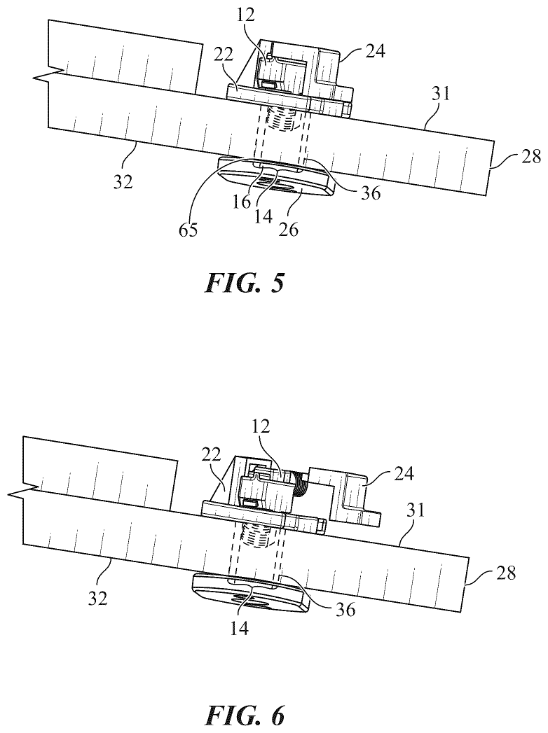

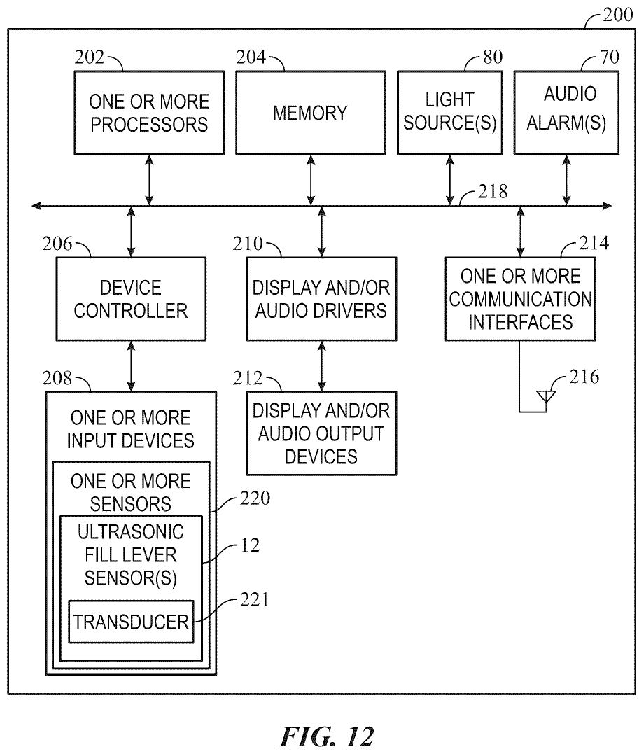

Referring to FIG. 5, in some embodiments, the sensing portion 14 of the ultrasonic fill level sensor 12 can be sized to extend at least partially through the aperture 36 in the lid 28 of the container (e.g. 30 in FIG. 4). In some embodiments, the sensing portion 14 can include a tubular body 16 and at least one transducer (e.g., 221 in FIG. 12), wherein the at least one transducer is positioned in the tubular body 16. In some embodiments, the at least one transducer can convert electrical energy into sound waves. In some embodiments, the at least one transducer can convert received sound waves into electrical energy.

Referring to FIG. 6, in some embodiments the ultrasonic fill level sensor 12 can be removeable from the cradle portion 22. For example, in some embodiments, the clamping portion 24 can be constructed and arranged to be unmounted so that the ultrasonic fill level sensor 12 is not retained by the clamping portion 24 while the cradle portion 22 is mounted on the top surface 31 of the lid 28 of the container (e.g. 30 in FIG. 4). The ultrasonic fill level sensor 12 can rest on the cradle portion 22 while the ultrasonic fill level sensor 12 is not retained by the clamping portion 24. As the ultrasonic fill level sensor 12 is not retained by the clamping portion 24, the ultrasonic fill level sensor 12 can be removed from the cradle portion 22 by lifting the ultrasonic fill level sensor 12 up from the cradle portion 22 as shown in FIG. 2.

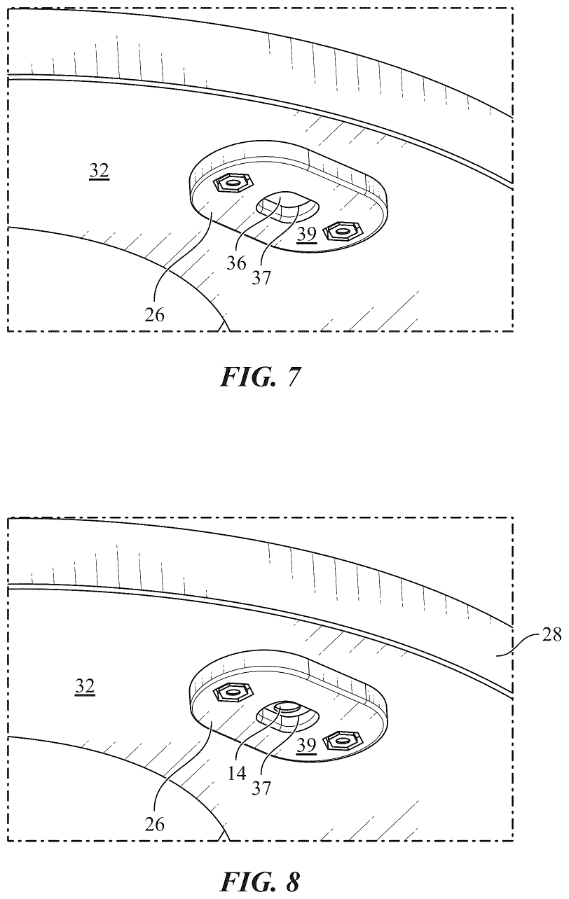

Referring to FIG. 7, in some embodiments, the underside protective portion 26 can be constructed and arranged to be mounted on a bottom surface 32 opposite the top surface (e.g., 31 in FIG. 6) of the lid 28 of the container (e.g. 30 in FIG. 4). In some embodiments, the underside protective portion 26 can have a second through-cavity 37. In some embodiments, the second through-cavity 37 can be constructed and arranged to be aligned with the aperture 36 in the lid 28 of the container (e.g. 30 in FIG. 4).

Referring to FIG. 8, in some embodiments, the second through-cavity 37 can be constructed and arranged to at least partially receive the sensing portion 14 of the ultrasonic fill level sensor 12 so that the sensing portion 14 does not extend below a bottom surface 39 of the underside protective portion 26. In some embodiments, the sensing portion 14 is at least partially in the second through-cavity 37 of the underside protective portion 26. In some embodiments, the underside protective portion 26 can protect the sensing portion 14 from being physically damaged.

Referring to FIGS. 1 and 2, in some embodiments, the second through-cavity 37 of the underside protective portion 26 can be constructed and arranged to be aligned with the first through-cavity 35 of the cradle portion 22. In some embodiments, a gasket 65 can be disposed along a groove 66 formed in a top surface 67 opposite the bottom surface 39 of the underside protective portion 26. Referring to FIG. 5, the gasket 65 can be constructed and arranged to be positioned between the bottom surface 32 of the lid 28 of the container (e.g., 30 in FIG. 4) and the underside protective portion 26. In some embodiments, the gasket can be constructed and arranged to be positioned around the ultrasonic fill level sensor 12. In some embodiments, the gasket can be made of any suitable material that can provide a seal against leaking solids, liquids, or a combination thereof.

In some embodiments, the ultrasonic fill level sensor 12 can be operably coupled to at least memory (e.g., 204 in FIG. 12) and one or more processors (e.g., 202 in FIG. 12). For example, referring to FIG. 4, in some embodiments, the ultrasonic fill level sensor 12 can be operably coupled to a controller 200 that includes the memory and the one or more processors. In some embodiments, the ultrasonic fill level sensor 12 can be operably coupled to the controller 200 by at least one electrical connection 40.

Referring to FIG. 9, in some embodiments, the fill level detection system 10 can include a plurality of ultrasonic fill level sensors 121, 122, 123, 124 and respective sensor mounts 131, 132, 133, 134. Each ultrasonic fill level sensor 121, 122, 123, 124 can be mounted on a respective container 141, 142, 143, 144 by a respective sensor mount 131, 132, 133, 134. While only four ultrasonic fill level sensors 121, 122, 123, 124, four sensor mounts 131, 132, 133, 134, and four containers 141, 142, 143, 144 are illustrated, the fill level detection system 10 can include any suitable number (e.g., one, two, three, etc.) of ultrasonic fill level sensors, sensor mounts, and containers.

In some embodiments, a controller (e.g., 200 in FIG. 4), the memory, the one or more processors, or any combination thereof, can be operably coupled to the ultrasonic fill level sensors 121, 122, 123, 124. In some embodiments, the one or more processors can be configured at least to receive any suitable sensor information from any ultrasonic fill level sensor 121, 122, 123, 124 to determine a fill level 51, 52, 53, 54 of any container 141, 142, 143, 144. Each container 141, 142, 143, 144 can be filled with material 160 while the one or more processors receive sensor information from the ultrasonic fill level sensors 121, 122, 123, 124.

In some embodiments, the one or more processors can be configured to determine if a fill level 51, 52, 53, 54 of any container 141, 142, 143, 144 meets (e.g., is greater than or equal to) a predetermined threshold 55 based at least on any received sensor information from the ultrasonic fill level sensors 121, 122, 123, 124. For example the one or more processors can be configured to determine that a fill level 51, 52, 53 meets a predetermined threshold 55 based at least on any received sensor information from the ultrasonic fill level sensors 121, 122, 123. As another example, the one or more processors can be configured to determine that a fill level 54 does not meet the predetermined threshold 55 based at least on any received sensor information from the ultrasonic fill level sensor 124.

Referring to FIG. 10, in some embodiments, the fill level detection system 10 can include one or more audio alarms 70 operably coupled to the one or more processors, wherein the one or more processors are further configured at least to activate a first audio alarm 71 of the one or more audio alarms 70 in response to determining that the fill level (e.g., 51, 52, 53 in FIG. 9) of a container (e.g., 141, 142, 143 in FIG. 9) meets a predetermined threshold (e.g., 55 in FIG. 9). In some embodiments, any of the audio alarms 71, 73 of the one or more audio alarms 70 can be activated when power is provided to the audio alarm.

In some embodiments, the one or more processors can be configured to receive user input to deactivate the first audio alarm 71. For example, a user can push an electronic button 72 to provide the user input to the one or more processors to deactivate the first audio alarm 71. In response, the one or more processors can deactivate the first audio alarm 71 in response to receiving the user input to deactivate the first audio alarm 71. In some embodiments, any of the audio alarms 71, 73 of the one or more audio alarms 70 can be deactivated when power is not provided to the audio alarm.

After a predetermined amount of time (e.g., one minute, two minutes, three minutes, etc.), the one or more processors can activate the first audio alarm 71. In some embodiments, the one or more processors can be configured to at least adjust the predetermined amount of time (e.g., by increasing or decreasing the predetermined amount of time). In some embodiments, the first audio alarm 71 can be reset so that the first audio alarm is not activated until the fill level of the container is determined to meet the predetermined threshold again.

In some embodiments, the fill level detection system 10 can include one or more indicator light sources 80 operably coupled to the one or more processors. In some embodiments, the one or more processors can be configured to activate at least a first indicator light source 81 of the one or more indicator light sources 80 in response to determining that a fill level (e.g., 51, 52, 53 in FIG. 9) of a container (e.g., 141, 142, 143 in FIG. 9) meets a predetermined threshold (e.g., 55 in FIG. 9). In some embodiments, any of the light sources 81, 82, 83, 84 can be activated when power is provided to the light source.

In some embodiments, each indicator light source 81, 82, 83, 84 can be associated with a respective ultrasonic fill level sensor (e.g., 12 in FIG. 4) mounted on a lid of a respective container (e.g., 141, 142, 143, 144 in FIG. 9) so that activation of a particular light source identifies the container whose fill level was determined to meet the predetermined threshold. In some embodiments, the one or more processors can be configured to receive user input to deactivate the first indicator light source 81. For example, a user can push an electronic button 77 to provide the user input to the one or more processors to deactivate the first indicator light source 81. In response to receiving the user input, the one or more processors can deactivate the first indicator light source 81. In some embodiments, any of the light sources 81, 82, 83, 84 can be deactivated when power is not provided to the light source. After a predetermined amount of time, the one or more processors can activate the first indicator light source. In some embodiments, the one or more processors can be configured to at least adjust the predetermined amount of time. In some embodiments, the first indicator light source 81 can be reset so that the first indicator light source 81 is not activated until the fill level of the container is determined to meet the predetermined threshold again.

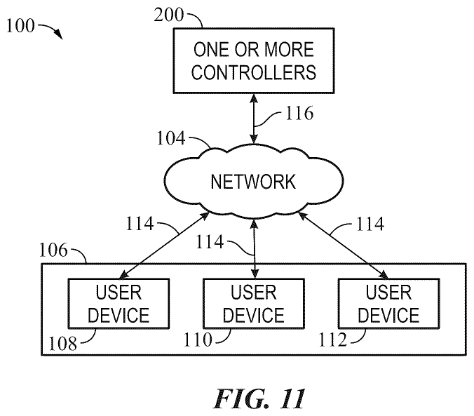

Referring to FIG. 11, a system 100 for detecting fill levels can be used with some embodiments disclosed herein. In some embodiments, system 100 can comprise one or more controllers 200, a network 104 (e.g., communication network), one or more user devices 106, or any combination thereof. In some embodiments, the one or more user devices 106 can include a first user device 108, a second user device 110, a third user device 112, or any combination thereof.

The one or more controllers 200 can be any suitable controller(s) for storing data, programs, or a combination thereof, for detecting fill levels. In some embodiments, the one or more controllers 200 can include one or more computing devices. In some embodiments, the one or more controllers 200 can be configured to send, to at least one user device 108, 110, 112 that is communicatively coupled to the fill level detection system (e.g., 10 in FIG. 1), a notification indicating that the fill level (e.g., 51, 52, 53 in FIG. 9) of a container (e.g., 30 in FIG. 4) meets a predetermined threshold (e.g., 55 in FIG. 9) in response to determining that the fill level of the container meets the predetermined threshold. In some embodiments, the at least one user device 108, 110, 112 can be remote from the fill level detection system (e.g., 10 in FIG. 4) or any component thereof. Since the at least one user device 108, 110, 112 and the one or more controllers 200 can be communicatively coupled by the network 104, the at least one user device 108, 110, 112 can be remote from the one or more controllers 200 by being any suitable distance (e.g., 1 mile, 2 miles, 3 miles, etc.) from the one or more controllers 200.

The network 104 can include a wired network, a wireless network, or a combination thereof. In some embodiments, the network 104 can include the Internet, an intranet, a wide-area network (WAN), a local-area network (LAN), a digital subscriber line (DSL) network, a frame relay network, an asynchronous transfer mode (ATM) network, a virtual private network (VPN), a cellular (LTE, 5G) network, any other suitable communication network, or any combination thereof. In some embodiments, one or more communications links 114 can connect the one or more user devices 106 to the network 104. In some embodiments, one or more communication links 116 can connect the network 104 to the one or more controllers 200 of a fill level detection system (e.g., 10 in FIG. 4). The one or more communication links 114, 116, can be any communication links suitable for communicating information between the one or more user devices 106 and the one or more controllers 200, such as, for example, network links, dial-up links, wireless links, hard-wired links, any other suitable communications links, or any combination thereof.

The one or more user devices 106 can be configured to request any data about a fill level detection system (e.g., 10 in FIG. 4) from the one or more controllers 200, and receive any data about the fill level detection system from the one or more controllers 200. In some embodiments, at least one user device 108, 110, 112 can be configured to receive, from at least one controller 200 that is communicatively coupled to the fill level detection system (e.g., 10 in FIG. 4), a notification indicating that the fill level (e.g., 51, 52, 53 in FIG. 9) of a container (e.g., 30 in FIG. 4) meets a predetermined threshold (e.g., 55 in FIG. 9). In some embodiments, the at least one user device 108, 110, 112 can be remote from the fill level detection system (e.g., 10 in FIG. 4) or any component thereof. For example, the at least one user device 108, 110, 112 can be remote from the one or more controllers 200.

In some embodiments, one or more computing devices can include a mobile device, such as a mobile phone, a tablet computer, a wearable computer, a laptop computer, a vehicle (e.g., a car, a boat, an airplane, or any other suitable vehicle), any other suitable mobile device, any suitable non-mobile device (e.g., a desktop computer, entertainment system, etc.), or any combination thereof. As another example, the one or more computing devices can include a media playback device, such as a television, a projector device, a game console, any other suitable computing device, or any combination thereof.

While the one or more controllers 200 are shown in FIG. 11 as one device to avoid over-complicating the figure, any suitable number of controllers can be used in some embodiments.

Although three user devices 108, 110, 112 are shown in FIG. 11 to avoid over-complicating the figure, any suitable number of user devices can be used in some embodiments.

In some embodiments, the one or more controllers 200 and the one or more user devices 106 can be implemented using any suitable hardware. For example, any device of the one or more controllers 200, and the one or more user devices 106 can be implemented using any suitable general-purpose computer or special-purpose computer. Any general-purpose computer or special-purpose computer can include any suitable hardware.

Referring to FIG. 12, an example hardware of a controller 200 is illustrated. In some embodiments, the controller 200 can include one or more processors 202, memory 204, a device controller 206, one or more input devices 208, display and/or audio drivers 210, display and/or audio output devices 212, one or more communication interfaces 214, one or more antennas 216, a bus 218, one or more light indicator light sources 80, one or more audio alarms 70, or any combination thereof.

In some embodiments, the one or more processors 202 can include any suitable hardware processor, such as a central processing unit (CPU), a graphics processing unit (GPU), a tensor processing unit (TPU), an accelerated processing unit (APU), any other type of processing unit, or any combination thereof. In some embodiments, the one or more processors 202 can include a microprocessor, a micro-controller, a digital signal processor, dedicated logic, an application-specific integrated circuit (ASIC), a field programmable gate array (FPGA), an accelerator (e.g., an artificial intelligence (AI) accelerator or a cryptographic accelerator), any other suitable circuitry for controlling the functioning of a general purpose computer or a special purpose computer, or any combination thereof.

In some embodiments, one or more processors 202 of any controller of the one or more controllers 200 can be controlled by a server program stored in memory 204 of the server. For example, in some embodiments, the server program can cause the one or more processors 202 to send, to at least one user device 108, 110, 112 that is communicatively coupled to a fill level detection system (e.g., 10 in FIG. 4), a notification indicating that the fill level (e.g., 51, 52, 53 in FIG. 9) of a container (e.g., 30 in FIG. 4) meets a predetermined threshold (e.g., 55 in FIG. 9) in response to determining that the fill level of the container meets the predetermined threshold.

In some embodiments, one or more processors 202 of any user device (e.g., 108, 110, 112 in FIG. 1) of the one or more user devices 106 can be controlled by a computer program stored in memory 204 of the user device. For example, the computer program can cause the one or more processors 202 to receive, from at least one controller 200 that is communicatively coupled to the fill level detection system (e.g., 10 in FIG. 4), a notification indicating that the fill level (e.g., 51, 52, 53, 54 in FIG. 9) of a container (e.g., 30 in FIG. 4) meets a predetermined threshold (e.g., 55 in FIG. 9).

In some embodiments, the memory 204 can include any suitable memory, storage, or a combination thereof for storing programs, data, and/or any other suitable information. For example, memory 204 can include volatile memory, non-volatile memory, or any combination thereof. In some embodiments, memory 204 can include random access memory, read-only memory, flash memory, a hard disk drive, a solid state drive, optical media, any other suitable memory, or any combination thereof.

In some embodiments, the device controller 206 can include any suitable processor or circuitry for controlling and receiving any input from the one or more input devices 208. In some embodiments, the one or more input devices 208 can include a touchscreen, a keyboard, a mouse, one or more buttons, a voice recognition circuit, a camera, one or more sensors 220, any other suitable input device, or any combination thereof. In some embodiments, the one or more sensors 220 can include at least one ultrasonic fill level sensor 12. In some embodiments, the one or more input devices 208 can be included in any device of the one or more controllers 200, the one or more user devices 106, or any combination thereof.

In some embodiments, the display and/or audio drivers 210 can include any suitable circuitry for controlling and driving output to one or more display and/or audio output devices 212. For example, the output devices can include a display (e.g., including a touchscreen, a flat-panel display, a cathode ray tube display, a projector, any other suitable display or presentation device, or any combination thereof), one or more speakers, or a combination thereof.

In some embodiments, the one or more communication interfaces 214 can include any suitable circuitry for interfacing with one or more communication networks, such as network 104 as shown in FIG. 11. For example, the one or more communication interfaces 214 can include network interface card circuitry, wired communication circuitry, wireless communication circuitry, any other suitable communication network circuitry, or any combination thereof.

In some embodiments, the one or more antennas 216 can wirelessly communicate with a communication network (e.g., network 104). In some embodiments, the one or more antennas 216 can be omitted.

In some embodiments, the bus 218 can include any suitable communication system for communicating data, addresses, control signals, power, or any combination thereof, between two or more components 202, 204, 206, 210, and 214. In some embodiments, the bus 218 can include any suitable conductors that are constructed and arranged to communicate data, addresses, control signals, power, or any combination thereof, between two or more components 202, 204, 206, 210, and 214.

In some embodiments, any other suitable component(s) can be included in the controller 200.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

According to variation 1, a fill level detection system can include an ultrasonic fill level sensor that includes a sensing portion; a sensor mount that includes a cradle portion, a clamping portion, and an underside protective portion; wherein: the cradle portion is constructed and arranged to be mounted on a top surface of a lid of a container; the cradle portion has a first through-cavity that is constructed and arranged to receive at least the ultrasonic fill level sensor; the first through-cavity is further constructed and arranged to be aligned with an aperture in the lid of the container; the sensing portion of the ultrasonic fill level sensor is sized to extend through the aperture in the lid of the container; the clamping portion is constructed and arranged to be mounted on the cradle portion; the clamping portion is further constructed and arranged to extend over at least the ultrasonic fill level sensor and retain the ultrasonic fill level sensor while the ultrasonic fill level sensor is received in the first through-cavity of the cradle portion; the clamping portion is further constructed and arranged to be unmounted so that the ultrasonic fill level sensor is not retained by the clamping portion while the cradle portion is mounted on the top surface of the lid of the container; the underside protective portion is constructed and arranged to be mounted on a bottom surface opposite the top surface of the lid of the container; the underside protective portion has a second through-cavity that is constructed and arranged to be aligned with the first through-cavity of the cradle portion and the aperture in the lid of the container; and the second through-cavity is further constructed and arranged to at least partially receive the sensing portion of the ultrasonic fill level sensor so that the sensing portion does not extend below a bottom surface of the underside protective portion; the fill level detection system further comprising: memory; and one or more processors operably coupled to at least the memory and the ultrasonic fill level sensor, the one or more processors configured at least to: receive first sensor information from the ultrasonic fill level sensor; determine that a fill level of the container meets a predetermined threshold based at least on the received first sensor information.

Variation 2 can include the fill level detection system of variation 1, wherein: the clamping portion includes a top jaw and a retaining protrusion extending from the top jaw, the top jaw being constructed and arranged to be positioned on at least the ultrasonic fill level sensor; the cradle portion has a vertical wall that includes a retaining hole; the retaining hole in the vertical wall is constructed and arranged to receive the retaining protrusion of the clamping portion to retain the ultrasonic fill level sensor.

Variation 3 can include the fill level detection system of variation 1, further comprising: a gasket disposed along a groove formed in a top surface opposite the bottom surface of the underside protective portion, wherein the gasket is constructed and arranged to be positioned between the bottom surface of the lid of the container and the underside protective portion, wherein the gasket is further constructed and arranged to be positioned around the ultrasonic fill level sensor.

Variation 4 can include the fill level detection system of variation 1, further comprising one or more audio alarms operably coupled to the one or more processors, wherein the one or more processors are further configured at least to: activate a first audio alarm of the one or more audio alarms in response to determining that the fill level of the container meets the predetermined threshold.

Variation 5 can include the fill level detection system of variation 4, wherein the one or more processors are further configured to: receive user input to deactivate the first audio alarm; deactivate the first audio alarm in response to receiving the user input to deactivate the first audio alarm; activate the first audio alarm after a predetermined amount of time in response to deactivating the first audio alarm.

Variation 6 can include the fill level detection system of variation 5, wherein the one or more processors are further configured to at least adjust the predetermined amount of time.

Variation 7 can include the fill level detection system of variation 1, further comprising one or more indicator light sources operably coupled to the one or more processors, wherein the one or more processors are further configured to: activate a first indicator light source of the one or more indicator light sources in response to determining that the fill level of the container meets the predetermined threshold.

Variation 8 can include the fill level detection system of variation 7, wherein the one or more processors are further configured to: receive user input to deactivate the first indicator light source; deactivate the first indicator light source in response to receiving the user input to deactivate the first indicator light source; activate the first indicator light source after a predetermined amount of time in response to deactivating the first indicator light source.

Variation 9 can include the fill level detection system of variation 8, wherein the one or more processors are further configured to at least adjust the predetermined amount of time.

Variation 10 can include the fill level detection system of variation 1, wherein the one or more processors are further configured at least to: send, to at least one user device that is communicatively coupled to the fill level detection system, a notification indicating that the fill level of the container meets the predetermined threshold in response to determining that the fill level of the container meets the predetermined threshold.

Variation 11 can include the fill level detection system of variation 10, wherein the at least one user device is remote from the fill level detection system.

According to variation 12, a fill level detection system can include an ultrasonic fill level sensor that includes a sensing portion; a sensor mount that includes a cradle portion, a clamping portion, and an underside protective portion; wherein: the cradle portion is mounted on a top surface of a lid of a container; the cradle portion has a first through-cavity that receives at least the ultrasonic fill level sensor; the first through-cavity is aligned with an aperture in the lid of the container; the sensing portion of the ultrasonic fill level sensor is sized to extend at least partially through the aperture in the lid of the container; the clamping portion is mounted on the cradle portion; the clamping portion extends over at least the ultrasonic fill level sensor and retains the ultrasonic fill level sensor while the ultrasonic fill level sensor is received in the first through-cavity of the cradle portion; the clamping portion is constructed and arranged to be unmounted so that the ultrasonic fill level sensor is not retained by the clamping portion while the cradle portion is mounted on the top surface of the lid of the container; the underside protective portion is mounted on a bottom surface opposite the top surface of the lid of the container; the underside protective portion has a second through-cavity that is aligned with the first through-cavity of the cradle portion and the aperture in the lid of the container; and the second through-cavity at least partially receives the sensing portion of the ultrasonic fill level sensor so that the sensing portion does not extend below a bottom surface of the underside protective portion; the fill level detection system further comprising: memory; and one or more processors operably coupled to at least the memory and the ultrasonic fill level sensor, the one or more processors configured at least to: receive first sensor information from the ultrasonic fill level sensor; determine that a fill level of the container meets a predetermined threshold based at least on the received first sensor information.

Variation 13 can include the fill level detection system of variation 12, wherein: the clamping portion includes a top jaw and a retaining protrusion extending from the top jaw, the top jaw being constructed and arranged to be positioned on at least the ultrasonic fill level sensor; the cradle portion has a vertical wall that includes a retaining hole; the retaining hole in the vertical wall is constructed and arranged to receive the retaining protrusion of the clamping portion to retain the ultrasonic fill level sensor.

Variation 14 can include the fill level detection system of variation 12, further comprising one or more audio alarms operably coupled to the one or more processors, wherein the one or more processors are further configured at least to: activate a first audio alarm of the one or more audio alarms in response to determining that the fill level of the container meets the predetermined threshold.

Variation 15 can include the fill level detection system of variation 12, further comprising one or more indicator light sources operably coupled to the one or more processors, wherein the one or more processors are further configured to: activate a first indicator light source of the one or more indicator light sources in response to determining that the fill level of the container meets the predetermined threshold.

Variation 16 can include the fill level detection system of variation 12, wherein the one or more processors are further configured at least to: send, to at least one user device that is communicatively coupled to the fill level detection system, a notification indicating that the fill level of the container meets the predetermined threshold in response to determining that the fill level of the container meets the predetermined threshold.

According to variation 17, a fill level detection system can include an ultrasonic fill level sensor that includes a sensing portion; a sensor mount that includes a cradle portion, a clamping portion, and an underside protective portion; wherein: the cradle portion is mounted on a top surface of a lid of a container; the cradle portion has a first through-cavity that receives at least the ultrasonic fill level sensor; the first through-cavity is aligned with an aperture in the lid of the container; the sensing portion of the ultrasonic fill level sensor is sized to extend at least partially through the aperture in the lid of the container; the clamping portion is constructed and arranged to be mounted on the cradle portion; the clamping portion is constructed and arranged to extend over at least the ultrasonic fill level sensor and retain the ultrasonic fill level sensor while the ultrasonic fill level sensor is received in the first through-cavity of the cradle portion; the clamping portion is unmounted so that the ultrasonic fill level sensor is not retained by the clamping portion while the cradle portion is mounted on the top surface of the lid of the container; the underside protective portion is mounted on a bottom surface opposite the top surface of the lid of the container; the underside protective portion has a second through-cavity that is aligned with the first through-cavity of the cradle portion and the aperture in the lid of the container; and the second through-cavity at least partially receives the sensing portion of the ultrasonic fill level sensor so that the sensing portion does not extend below a bottom surface of the underside protective portion; the fill level detection system further comprising: memory; and one or more processors operably coupled to at least the memory and the ultrasonic fill level sensor, the one or more processors configured at least to: receive first sensor information from the ultrasonic fill level sensor; determine that a fill level of the container meets a predetermined threshold based at least on the received first sensor information.

Variation 18 can include the fill level detection system of variation 17, further comprising one or more audio alarms operably coupled to the one or more processors, wherein the one or more processors are further configured at least to: activate a first audio alarm of the one or more audio alarms in response to determining that the fill level of the container meets the predetermined threshold.

Variation 19 can include the fill level detection system of variation 17, further comprising one or more indicator light sources operably coupled to the one or more processors, wherein the one or more processors are further configured to: activate a first indicator light source of the one or more indicator light sources in response to determining that the fill level of the container meets the predetermined threshold.

Variation 20 can include the fill level detection system of variation 17, wherein the one or more processors are further configured at least to: send, to at least one user device that is communicatively coupled to the fill level detection system, a notification indicating that the fill level of the container meets the predetermined threshold in response to determining that the fill level of the container meets the predetermined threshold.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for anyone of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible considering the above teachings without departing from the following claims.

What is claimed is:

1. A fill level detection system, comprising:
an ultrasonic fill level sensor that includes a sensing portion;
a sensor mount that includes a cradle portion, a clamping portion, and an underside protective portion; wherein:
the cradle portion is constructed and arranged to be mounted on a top surface of a lid of a container;
the cradle portion has a first through-cavity that is constructed and arranged to receive at least the ultrasonic fill level sensor;
the first through-cavity is further constructed and arranged to be aligned with an aperture in the lid of the container;
the sensing portion of the ultrasonic fill level sensor is sized to extend at least partially through the aperture in the lid of the container;
the clamping portion is constructed and arranged to be mounted on the cradle portion;
the clamping portion is further constructed and arranged to extend over at least the ultrasonic fill level sensor and retain the ultrasonic fill level sensor while the ultrasonic fill level sensor is received in the first through-cavity of the cradle portion;
the clamping portion is further constructed and arranged to be unmounted so that the ultrasonic fill level sensor is not retained by the clamping portion while the cradle portion is mounted on the top surface of the lid of the container;
the underside protective portion is constructed and arranged to be mounted on a bottom surface opposite the top surface of the lid of the container;
the underside protective portion has a second through-cavity that is constructed and arranged to be aligned with the first through-cavity of the cradle portion and the aperture in the lid of the container; and
the second through-cavity is further constructed and arranged to at least partially receive the sensing portion of the ultrasonic fill level sensor so that the sensing portion does not extend below a bottom surface of the underside protective portion;
the fill level detection system further comprising:
memory; and
one or more processors operably coupled to at least the memory and the ultrasonic fill level sensor, the one or more processors configured at least to:
receive first sensor information from the ultrasonic fill level sensor;
determine that a fill level of the container meets a predetermined threshold based at least on the received first sensor information.

2. The fill level detection system of claim 1, wherein:
the clamping portion includes a top jaw and a retaining protrusion extending from the top jaw, the top jaw being constructed and arranged to be positioned on at least the ultrasonic fill level sensor;
the cradle portion has a vertical wall that includes a retaining hole;
the retaining hole in the vertical wall is constructed and arranged to receive the retaining protrusion of the clamping portion to retain the ultrasonic fill level sensor.

3. The fill level detection system of claim 1, further comprising:
a gasket disposed along a groove formed in a top surface opposite the bottom surface of the underside protective portion, wherein the gasket is constructed and arranged to be positioned between the bottom surface of the lid of the container and the underside protective portion, wherein the gasket is further constructed and arranged to be positioned around the ultrasonic fill level sensor.

4. The fill level detection system of claim 1, further comprising one or more audio alarms operably coupled to the one or more processors, wherein the one or more processors are further configured at least to:
activate a first audio alarm of the one or more audio alarms in response to determining that the fill level of the container meets the predetermined threshold.

5. The fill level detection system of claim 4, wherein the one or more processors are further configured to:
receive user input to deactivate the first audio alarm;
deactivate the first audio alarm in response to receiving the user input to deactivate the first audio alarm;
activate the first audio alarm after a predetermined amount of time in response to deactivating the first audio alarm.

6. The fill level detection system of claim 5, wherein the one or more processors are further configured to at least adjust the predetermined amount of time.

7. The fill level detection system of claim 1, further comprising one or more indicator light sources operably coupled to the one or more processors, wherein the one or more processors are further configured to:
activate a first indicator light source of the one or more indicator light sources in response to determining that the fill level of the container meets the predetermined threshold.

8. The fill level detection system of claim 7, wherein the one or more processors are further configured to:
receive user input to deactivate the first indicator light source;
deactivate the first indicator light source in response to receiving the user input to deactivate the first indicator light source;
activate the first indicator light source after a predetermined amount of time in response to deactivating the first indicator light source.

9. The fill level detection system of claim 8, wherein the one or more processors are further configured to at least adjust the predetermined amount of time.

10. The fill level detection system of claim 1, wherein the one or more processors are further configured at least to:
send, to at least one user device that is communicatively coupled to the fill level detection system, a notification indicating that the fill level of the container meets the predetermined threshold in response to determining that the fill level of the container meets the predetermined threshold.

11. The fill level detection system of claim 10, wherein the at least one user device is remote from the fill level detection system.

12. A fill level detection system, comprising:
an ultrasonic fill level sensor that includes a sensing portion;
a sensor mount that includes a cradle portion, a clamping portion, and an underside protective portion; wherein:
the cradle portion is mounted on a top surface of a lid of a container;
the cradle portion has a first through-cavity that receives at least the ultrasonic fill level sensor;
the first through-cavity is aligned with an aperture in the lid of the container;
the sensing portion of the ultrasonic fill level sensor is sized to extend at least partially through the aperture in the lid of the container;
the clamping portion is mounted on the cradle portion;
the clamping portion extends over at least the ultrasonic fill level sensor and retains the ultrasonic fill level sensor while the ultrasonic fill level sensor is received in the first through-cavity of the cradle portion;
the clamping portion is constructed and arranged to be unmounted so that the ultrasonic fill level sensor is not retained by the clamping portion while the cradle portion is mounted on the top surface of the lid of the container;
the underside protective portion is mounted on a bottom surface opposite the top surface of the lid of the container;
the underside protective portion has a second through-cavity that is aligned with the first through-cavity of the cradle portion and the aperture in the lid of the container; and
the second through-cavity at least partially receives the sensing portion of the ultrasonic fill level sensor so that the sensing portion does not extend below a bottom surface of the underside protective portion;
the fill level detection system further comprising:
memory; and
one or more processors operably coupled to at least the memory and the ultrasonic fill level sensor, the one or more processors configured at least to:
receive first sensor information from the ultrasonic fill level sensor;
determine that a fill level of the container meets a predetermined threshold based at least on the received first sensor information.

13. The fill level detection system of claim 12, wherein:
the clamping portion includes a top jaw and a retaining protrusion extending from the top jaw, the top jaw being constructed and arranged to be positioned on at least the ultrasonic fill level sensor;
the cradle portion has a vertical wall that includes a retaining hole;
the retaining hole in the vertical wall is constructed and arranged to receive the retaining protrusion of the clamping portion to retain the ultrasonic fill level sensor.

14. The fill level detection system of claim 12, further comprising one or more audio alarms operably coupled to the one or more processors, wherein the one or more processors are further configured at least to:
activate a first audio alarm of the one or more audio alarms in response to determining that the fill level of the container meets the predetermined threshold.

15. The fill level detection system of claim 12, further comprising one or more indicator light sources operably coupled to the one or more processors, wherein the one or more processors are further configured to:
activate a first indicator light source of the one or more indicator light sources in response to determining that the fill level of the container meets the predetermined threshold.

16. The fill level detection system of claim 12, wherein the one or more processors are further configured at least to:
send, to at least one user device that is communicatively coupled to the fill level detection system, a notification indicating that the fill level of the container meets the predetermined threshold in response to determining that the fill level of the container meets the predetermined threshold.

17. A fill level detection system, comprising:
an ultrasonic fill level sensor that includes a sensing portion;
a sensor mount that includes a cradle portion, a clamping portion, and an underside protective portion; wherein:
the cradle portion is mounted on a top surface of a lid of a container;
the cradle portion has a first through-cavity that receives at least the ultrasonic fill level sensor;
the first through-cavity is aligned with an aperture in the lid of the container;
the sensing portion of the ultrasonic fill level sensor is sized to extend at least partially through the aperture in the lid of the container;
the clamping portion is constructed and arranged to be mounted on the cradle portion;
the clamping portion is constructed and arranged to extend over at least the ultrasonic fill level sensor and retain the ultrasonic fill level sensor while the ultrasonic fill level sensor is received in the first through-cavity of the cradle portion;
the clamping portion is unmounted so that the ultrasonic fill level sensor is not retained by the clamping portion while the cradle portion is mounted on the top surface of the lid of the container;
the underside protective portion is mounted on a bottom surface opposite the top surface of the lid of the container;
the underside protective portion has a second through-cavity that is aligned with the first through-cavity of the cradle portion and the aperture in the lid of the container; and
the second through-cavity at least partially receives the sensing portion of the ultrasonic fill level sensor so that the sensing portion does not extend below a bottom surface of the underside protective portion;
the fill level detection system further comprising:
memory; and
one or more processors operably coupled to at least the memory and the ultrasonic fill level sensor, the one or more processors configured at least to:
receive first sensor information from the ultrasonic fill level sensor;
determine that a fill level of the container meets a predetermined threshold based at least on the received first sensor information.

18. The fill level detection system of claim 17, further comprising one or more audio alarms operably coupled to the one or more processors, wherein the one or more processors are further configured at least to:
activate a first audio alarm of the one or more audio alarms in response to determining that the fill level of the container meets the predetermined threshold.

19. The fill level detection system of claim 17, further comprising one or more indicator light sources operably coupled to the one or more processors, wherein the one or more processors are further configured to:
activate a first indicator light source of the one or more indicator light sources in response to determining that the fill level of the container meets the predetermined threshold.

20. The fill level detection system of claim 17, wherein the one or more processors are further configured at least to:
send, to at least one user device that is communicatively coupled to the fill level detection system, a notification indicating that the fill level of the container meets the predetermined threshold in response to determining that the fill level of the container meets the predetermined threshold.
